(19) United States
(12) Patent Application Publication
(10) Pub. No.: US 2015/0075317 A1
(43) Pub. Date: Mar. 19, 2015

(54) Brake Pedal Cover

(71) Applicant: Alfred Donegan, Maryville, TN (US)

(72) Inventor: Alfred Donegan, Maryville, TN (US)

(21) Appl. No.: 14/484,023

(22) Filed: Sep. 11, 2014

Related U.S. Application Data
(60) Provisional application No. 61/879,410, filed on Sep. 18, 2013.

(51) Int. Cl. B60T 7/04; G05G 1/483

(52) U.S. Cl. CPC B60T 7/04; G05G 1/483
USPC 74/512

(57) ABSTRACT

Disclosed is a brake pedal cover that is adapted to assist a driver in easily distinguishing the brake pedal from the accelerator pedal. The cover of the present invention is substantially unitary in structure. The cover is constructed to snugly fit over an existing brake pedal. In a preferred embodiment, the cover may be composed of rubber, silicone, or other resilient material. The resilient nature of the cover allows the cover to conform to the shape of the brake pedal while tightly hugging the same without requiring additional fasteners. In one embodiment, the cover of the present invention is red in color so as to increase the visibility of the brake pedal. In other embodiments, however, the cover of the present invention may comprise other colors or printed designs thereon. In this way, the present invention is adapted to increase the visibility of the brake pedal.

### CROSS REFERENCE TO RELATED APPLICATION

This application claims the benefit of U.S. Provisional Application No. 61/879,410 filed on Sep. 18, 2013. The above identified patent application is herein incorporated by reference in its entirety to provide continuity of disclosure.

### BACKGROUND OF THE INVENTION

1. Field of the Invention

The present invention relates to a brake pedal cover. More specifically, the present invention pertains to an improved brake pedal cover that is adapted to fit over existing brake pedals. The brake pedal cover of the present invention is brightly colored so that a user can easily distinguish the brake pedal from the accelerator pedal.

Brake pedals are generally constructed from the same material as the accelerator pedals. Although some brake pedals are larger in size compared to the accelerator pedals, many drivers have difficulty in distinguishing the difference in size between the brake pedal and the accelerator pedal when pressing the pedals with their shoes on. Additionally, the brake pedals and accelerator pedals are placed closely together and tend to feel similar to one another when the user pushes his or her foot on either of the pads. As a result, inexperienced drivers may accidentally step on an accelerator pedal instead of stepping on a brake pedal, and vice versa. This can be extremely problematic and dangerous as it can easily cause vehicular accidents. Thus, an effective solution for drivers to increase vehicle safety is necessary.

The present invention provides means to differentiate the brake pedal from an accelerator pedal, a clutch pedal, or the like. The present invention discloses a cover that is adapted to completely span over the exterior surface of the brake pedal without requiring fastening means. The cover is composed of rubber, silicone, or other suitable resilient and flexible material. In the preferred embodiment, the cover may be red in color so that the brake pedal is easily identifiable to the driver, thereby preventing the user from accidentally pressing on the accelerator or clutch pedal instead of the brake pedal when stopping the vehicle. In other embodiments, however, the cover may comprise other highly visible colors so as to suit the user's preferences. The present invention may be suitable for use with new and existing brake pedals in various types of vehicles.

2. Description of the Prior Art

Devices have been disclosed in the prior art that claim brake pedal covers. These include devices that have been patented and published in patent application publications, and generally relate to covers for increasing friction on the brake pedal surface. Some of these devices disclose brake pedal covers having a top member and a bottom member that may be removably attached to the top surface of a brake pedal, wherein the cover comprises a plurality of anti-slip treading thereon. Other devices disclose a plate with a plurality of apertures thereon, wherein the plate may be mounted onto the top of a brake pedal via a strap system. These devices, however, do not disclose a brake pedal cover that is unitary in structure and that increases the visibility of the brake pedal to the driver. The foregoing is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 6,622,592 to Lee comprises an attachable brake pedal cover having a rectangular top member and a rectangular base member. The top member comprises a plurality of apertures thereon, and a plurality of tabs that extend downwardly therefrom. The base member comprises a plurality of protruding members. The apertures on the top member and the protruding members on the base member are adapted to align so that each of the protruding members are adapted to insert through the apertures on the top member when the top member and the base member are connected. When installed, the top member and the base member are adapted to snap onto the top surface of a brake pedal. Unlike the present invention, therefore, the device of Lee does not comprise brake cover that is unitary in structure, and that is flexible and resilient in nature. The present invention is adapted to cover the exterior of an existing brake pedal without fastening means. Thus, the present invention is advantageous in the fact that it is simple in construction and is easy to install.

Similarly, U.S. Pat. No. 5,913,948 to Lien discloses a skid-proof cover for an accelerator pedal, a brake pedal, and a clutch pedal of a motor vehicle. The cover comprises a plate, a fastening piece, an actuating piece, an actuating bolt, and a locating device. The plate comprises a skid-proof surface and is mounted on the fastening piece. The fastening piece is fastened to the pedal in conjunction with the actuating piece and the locating piece. In contrast, the present invention comprises a cover that is substantially unitary in structure. The cover of the present invention is composed of a resilient, flexible material such that the cover can be stretched and fitted over the exterior surface of the brake pedal without requiring any fastening means. In this way, the present invention is convenient to install and uninstall onto an existing brake pedal of a vehicle.

U.S. Pat. No. 6,619,156 to Super discloses a skid resistant cover assembly for vehicle pedals, comprising a rigid top plate provided with a high friction surface. The top plate is removably attached to the support plate therebelow, wherein the support plate is clamped to the vehicle pedal by means of a strap system. While the device of Super discloses a cover for vehicle pedals, the present invention differs from the device of Super in that the device of Super is intended to increase skid resistant properties of the brake pedal whereas the present invention is intended to increase the visibility of the brake pedal. As such, the present invention comprises a bright color that is easily visible for the driver.

U.S. Pat. No. 1,494,983 to Sinclair discloses a pedal pad comprising a substantially oval frame having a side guard extending upwardly therefrom, and a plurality of pliable fasteners downwardly extending therefrom. The frame is adapted to receive an oval shaped pad thereon. The pad comprises a treaded surface that is cushioned. While the treading on the surface of the pad helps prevent the driver's foot from slipping off of the brake pedal, the purpose and design of the Sinclair device differ significantly from the present invention in that the present invention discloses a brake pedal cover, not a brake pedal pad. Accordingly, the device of Sinclair does not disclose a cover that is adapted to snugly fit over an existing brake pedal.

Finally, U.S. Design Pat. No. D372448 to Hoist discloses a foot pad comprising a rectangular member having a recessed upper surface and side walls extending downward therefrom. The side walls comprise a pair of tabs for engaging a pedal mechanism. The recessed upper surface comprises a layer of high friction material thereon. The Hoist device, however, does not disclose a brake pedal cover that is composed of a resilient material such as rubber or silicone. Rather, the Hoist device is adapted to snap onto the front portion of an existing brake pedal.

The devices disclosed in the prior art have several known drawbacks. These devices are limited in that these devices fail to disclose means to increase the visibility of a brake pedal to the driver so as to easily distinguish the brake pedal from the accelerator pedal and clutch pedal. Additionally, the prior art devices relate to rigid covers. The present invention overcomes these limitations by disclosing a cover that is brightly colored so that it is easily visible to the driver, wherein the cover is flexible and pliable. Thus, the present invention can be stretched to snugly fit pedals of different sizes. Furthermore, the structural design of the present invention increases the ease of installation such that the cover may be installed without use of any tools and without altering the structure of the brake pedal. It is therefore submitted that the present invention is substantially divergent in design elements from the prior art, and consequently it is clear that there is a need in the art for an improvement to brake pedal covers. In this regard, the instant invention substantially fulfills these needs.

### SUMMARY OF THE INVENTION

In view of the foregoing disadvantages inherent in the known types of brake pedal covers now present in the prior art, the present invention provides a new and improved brake pedal cover wherein the same can be utilized for increasing the visibility of a brake pedal to the driver.

It is therefore an object of the invention to provide a new and improved brake pedal cover that has all of the advantages of the prior art and none of the disadvantages.

Another object of the present invention is to provide a new and improved brake pedal cover that is composed of resilient and flexible material to snugly fit over a new or an existing brake pedal and secured thereto without requiring the use of fastening means.

Yet another object of the present invention is to provide a new and improved brake pedal cover that offers improved flexibility with respect to the type of brake pedal being installed onto, increasing the number of applications for the same cover.

Still yet another object of the present invention is to provide a new and improved brake pedal cover that is bright in color so that it is easily visible to the driver.

Still yet another object of the present invention is to provide a new and improved brake pedal cover having a ridged surface to increase friction on the surface of the brake pedal.

A final another object of the present invention is to provide a new and improved brake pedal cover that may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a front view of an embodiment of the cover of the present invention.

FIG. 2 shows a rear view of an embodiment of the cover of the present invention.

FIG. 3 shows a front perspective view of an embodiment of the present invention as installed on a brake pedal.

FIG. 4 shows a rear perspective view of an embodiment of the present invention as installed on a brake pedal.

### DETAILED DESCRIPTION OF THE INVENTION

References are made herein to the attached drawings. Like reference numerals are used throughout the drawings to depict like or similar elements of the brake pedal cover. For the purposes of presenting a brief and clear description of the present invention, the preferred embodiment will be discussed as used to increase the visibility of a brake pedal to the driver. The figures are intended for representative purposes only and should not be considered to be limiting in any respect.

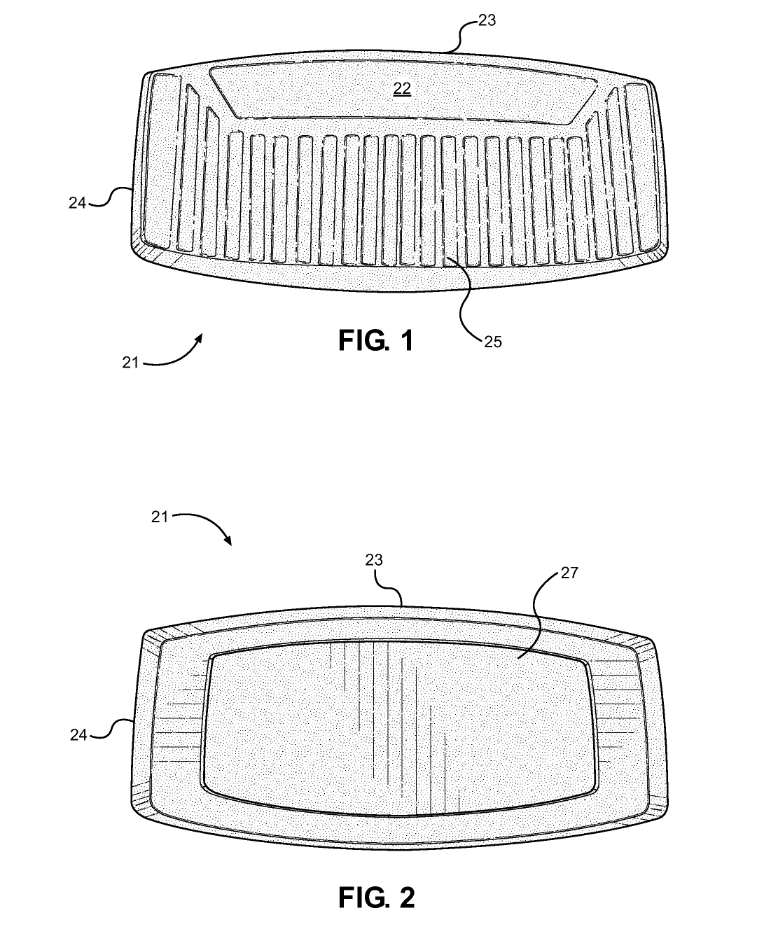

Referring now to FIGS. 1 and 2, there are shown front and rear views of an embodiment of the present invention, respectively. The present invention comprises a brake pedal cover 21 that is substantially unitary in structure. The brake pedal cover 21 comprises a closed front surface 22, an open rear portion, a pair of lateral edges 23, a pair of longitudinal edges 24, and a defined interior volume. The brake pedal cover 21 preferably includes a quadrilateral shape. The brake pedal cover 21 is shaped to enclose a brake pedal therein. Accordingly, the front surface 22 has a sufficiently large surface area so that the cover 21 can fit over a wide variety of different brake pedal shapes, sizes, and contours.

The front surface 22 further comprises a plurality of ridges 25 thereon so as to provide a slip-resistant surface. It is preferred that the ridges 25 span the entire front surface 22 so that the brake pedal does not slip under the driver's foot regardless of the placement of the driver's foot on the pedal. In the illustrated embodiment, the ridges 25 are elongated and substantially rectangular in shape. Additionally, the ridges 25 are integral to the cover 21. In other embodiments, however, the ridges 25 may be permanently affixed to the front surface 22 of the cover by means of a strong adhesive.

The lateral edges 23 of the brake pedal cover 21 are curved so that the curved portion extends away from the front surface 22. In contrast, the longitudinal edges 24 are substantially straight and parallel to each other. In the illustrated embodiment, the length of the lateral edges 23 are greater than the length of the longitudinal edges 24, similar to conventional brake pedals. It is contemplated that the front surface 22 is substantially planar. As such, each of the lateral edges 23 and the longitudinal edges 24 are coplanar. The lateral edges 23 and the longitudinal edges 24 extend toward the rear of the cover 21 so as to create a centralized opening 27 on the rear portion thereof. The opening 27 has an elongated shape, such as an oval shape or a rectangular shape. The oval or rectangular shapes match the typical shape of a conventional brake pedal so that the brake pedal can easily be placed therein.

It is contemplated that the brake pedal cover 21 is composed of rubber, silicone, or other suitable resilient, flexible, and durable material. Being of resilient material, the brake pedal cover 21 not only readily adjusts itself to the brake pedal when installed thereon, but snugly and tightly fits the same. Further, the present brake pedal cover 21 is provided in a bright, vibrant color to increase visibility to the user. In a preferred embodiment, the brake pedal cover 21 is red to draw the driver's attention. However, it is contemplated that other bright, vibrant colors that are different from the color of the accelerator pedal or clutch pedal may be used. In some embodiments, the brake pedal cover 21 may comprise a printed design thereon. In other embodiments, the brake pedal cover 21 may comprise fluorescent pigment so that it can glow in the dark. Thus, the present invention improves the visibility of the brake pedal when the brake pedal cover 21 is placed thereon.

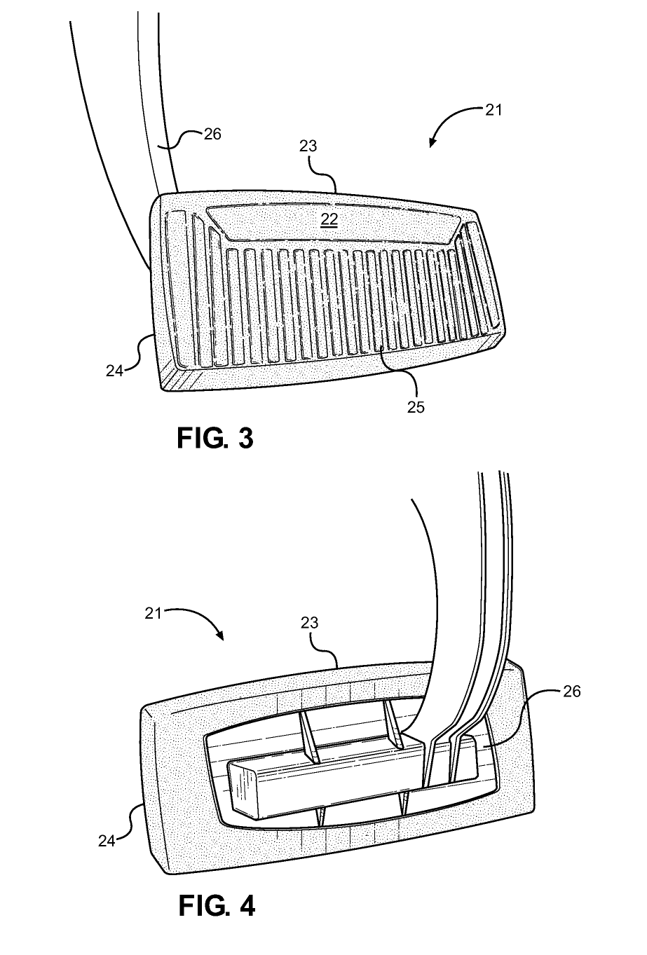

Referring now to FIGS. 3 and 4, there are shown front and rear perspective views of the present invention as installed on a brake pedal 26. In use, a brake pedal 26 can be inserted into the interior volume of the brake pedal cover 21 through the opening thereon. The brake pedal cover 21 can be stretched about the brake pedal 26 so as to enclose the brake pedal 26 thereon. Thus, the front surface of the cover 21 completely wraps around the front of the pedal; and the lateral edges 23 and longitudinal edges 24 wrap around the perimeter of the brake pedal 26 so that the pedal 26 is not visible when viewed from the front. Because the cover 21 comprises an opening on the rear portion thereof, the cover 21 does not interfere with the functionality of the brake pedal assembly. Accordingly, the inner surface of the cover 21 directly contacts the brake pedal when placed thereon. The brake pedal cover 21 is resilient and thus snugly and tightly grips the brake pedal 26 when installed thereon, and is held on the brake pedal 26 without the need of additional fastening means. Moreover, the brake pedal cover 21 may be stretched in the direction of its length and width when being installed on the brake pedal 26, and thus is under tension which serves to hold the brake pedal cover 21 on the brake pedal 26 without additional fastening means.

The brake pedal cover 21 of the present invention is adapted for use with new and existing brake pedals of various shapes and sizes to accommodate brake pedals on different make, model, and year of a vehicle. Being flexible, the brake pedal cover 21 may be stretched to fit brake pedals 26 of different length, and when installed, the brake pedal cover 21 will automatically adjust itself to the shape and size of the brake pedal 26 by reason of its resilient properties. In this respect, the brake pedal cover 21 is not limited to the structure of the brake pedal 26 being installed onto, as it can be stretched over brake pedal 26 of various sizes. Therefore, present invention increase the versatility and the ease of installation over new and existing brake pedals.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A brake pedal cover, comprising:
a cover having a front surface and an rear portion having an opening thereon, a pair of lateral edges, a pair of longitudinal edges, and a defined interior volume;
wherein said cover is shaped to fit a brake pedal within said interior volume;
each of said pair of lateral edges and said pair of longitudinal edges extending toward said rear portion;
wherein said opening is adapted to receive said brake pedal to enclose said brake pedal in said interior volume;
said front surface comprising a plurality of treading thereon.

2. The brake pedal cover of claim 1, wherein said cover is composed of rubber.

3. The brake pedal cover of claim 1, wherein said cover is composed of silicone.

4. The brake pedal cover of claim 1, wherein said pair of lateral edges are curved.

5. The brake pedal cover of claim 1, wherein said pair of longitudinal edges are straight and are substantially planar and parallel to each other.

6. The brake pedal cover of claim 1, wherein said cover is provided is at least one color that is a color different from a color of an accelerator pedal and a clutch pedal.

7. The brake pedal cover of claim 1, wherein said opening is substantially oval in shape.

8. The brake pedal cover of claim 1, wherein said plurality of treading is elongated.
